(19) United States
(12) Patent Application Publication
(10) Pub. No.: US 2007/0090645 A1
(43) Pub. Date: Apr. 26, 2007

(54) Pipe joint

(75) Inventors: Rolf Fadini, Leutenbach (DE); Sandra Gnann, Winnenden-Hoefen (DE); Friedrich Gugel, Roth/Eckenrsmuehlen (DE); Martin Roehm, Herrenberg (DE); Hans-Juergen Strassner, Neustadt (DE)

Correspondence Address: CROWELL & MORING LLP;INTELLECTUAL PROPERTY GROUP, P.O. BOX 14300, WASHINGTON, DC, 20044-4300, US

(73) Assignees: DAIMLERCHRYSLER AG, Stuttgart (DE); PETER HUFNAGEL GMBH, Roth/Eckersmuehlen (DE)

(21) Appl. No.: 10/577,796

(22) PCT Filed: Oct. 27, 2004
(86) PCT No.: PCT/EP04/12128

§ 371 Date: Dec. 19, 2006

(30) Foreign Application Priority Data
Oct. 30, 2003 (DE) 103 50 682.9

(51) Int. Cl. F16L 23/00

(52) U.S. Cl. 285/364

(57) ABSTRACT

The invention relates to a pipe joint for connecting a first pipe part (1) and a second pipe part (2), in particular for an exhaust-gas system of an internal combustion engine, having a fastening means (3) and a sealing element (4) which has a sleeve (5) and a sealing ring (6).

According to the invention, the sleeve (5) has a radially widened portion (8) at its first end (7) and can be pushed into the first pipe part (1) such that the widened portion (8) engages behind a circumferential constriction (11) of the first pipe part (1). The pipe joint according to the invention is suitable, in particular, for the gas-tight connection of exhaust pipes of motor vehicles.

### BACKGROUND AND SUMMARY OF THE INVENTION

This invention relates to a pipe joint for connecting two pipe parts, in particular for an exhaust-gas system of an internal combustion engine.

U.S. Pat. No. 1,959,630 describes a device for connecting two pipe parts which has a sleeve and a sealing ring wound around the sleeve. For the purpose of connecting the pipe parts, the sleeve is pushed part of the way into one of the pipe parts and the other pipe part is plugged onto the free sleeve part. By means of a clamp, which is positioned around the widened ends of the pipe parts and tightened, the pipe parts are pressed axially, by way of their widened ends, toward one another and against the sealing ring to produce a fixed pipe joint.

Accordingly, the object of the invention is to specify a pipe joint for connecting two pipe parts, in particular for an exhaust-gas system of an internal combustion engine, which allows simplified assembly.

This object is achieved by a pipe joint having the features claimed.

The pipe joint according to the invention has a sealing element with a sleeve and a sealing ring and is distinguished in that the sleeve has a radially widened portion at its first end and can be pushed into the first pipe part such that the widened portion engages behind a circumferential constriction of the first pipe part. By virtue of this design measure according to the invention, the sealing element, once pushed in, is fixed axially in the pipe part. This has the advantage that it is no longer possible for it to slide out of the pipe part during assembly, in particular in the case of a more or less vertically running pipe.

In one configuration of the invention, the radially widened portion of the sleeve is designed to project in the manner of teeth. The widened portion is preferably bounded by notches in the circumferential direction and is of comparatively narrow design. This reduces the amount of force which is necessary, when the sealing element is pushed in, in order to negotiate the circumferential constriction. It is advantageous to provide a few projecting portions distributed symmetrically along the circumferential end of the sleeve, as a result of which tilting is avoided during assembly.

In a further configuration of the invention, the sleeve has a conically tapered portion at its second end. This makes it easier for the second pipe part to be plugged on.

In a further configuration of the invention, the sealing ring encloses the sleeve in an annular manner and is connected to the sleeve in a form-fitting manner. The sealing ring is thus fixed in position all the way round at an envisaged location of the sleeve and cannot slide off the sleeve when the sealing element is pushed in. It is advantageous if the sealing ring encloses the sleeve in a force-fitting manner. In particular, the sealing ring may be connected to the sleeve in a non-releasable manner to give a single-piece sealing element.

A further configuration of the invention provides for the sealing ring to be designed in a cross-sectionally frustoconical manner with a rectilinear starting region, the radially outer region having a smaller width than the radially inner region. The fact that the cross section is frustoconical in certain regions gives rise to oblique flanks and, in the case of widened ends of the pipe parts which are to be connected, these ends can be pressed against the flanks in a form-fitting manner. This achieves a high level of sealing, which is important, in particular, for exhaust-pipe parts which are to be connected. The widened rectilinear starting region, by means of which the sealing ring is connected to the sleeve, gives rise to a mechanically stable and robust sealing element.

In a further configuration of the invention, the sealing ring is made of a graphite-filled knitted wire fabric. The knitted wire fabric, on the one hand, achieves a certain amount of strength but, at the same time, a change in shape is possible, as a result of which the sealing ring can be forced in a flush manner against a sealing surface even if the latter exhibits certain unevennesses.

In a further configuration of the invention, the first pipe part and the second pipe part each have a funnel-like widened portion at their connecting end. In the case of a sealing ring with an at least partially frustoconical cross section, it is advantageous here if the angle of the widened portions of the pipe parts corresponds at least more or less to the flank angle of the sealing ring, with the result that, when the pipe parts are brought together, they butt against the flanks by way of their widened portions.

In a further configuration of the invention, the fastening means is designed as a clamp which is open at at least one location and has cross-sectionally oblique flanks and a radially projecting closure part. In the case of widened pipe-part end regions, the flanks of the clamp engage behind the widened portions of the pipe parts. The flank angle of the clamp here preferably corresponds approximately to that of the widened portions of the pipe parts. A screw connection is preferably provided for the closure part of the clamp, it being possible for the clamp to be tightened by this screw connection and the pipe parts thus being pressed toward one another and against the sealing ring to produce a fixed pipe joint.

Advantageous embodiments of the invention are described hereinbelow and illustrated in the drawings.

### BRIEF DESCRIPTION OF THE DRAWINGS

FIG. 1 shows a schematic cross-sectional illustration of a preferred embodiment of the pipe joint according to the invention,

FIG. 2 shows a schematic cross-sectional illustration, in detail form, of a preferred embodiment of the sealing element assigned to the pipe joint, and

FIG. 3 shows a schematic view in perspective of a preferred embodiment of the pipe joint according to the invention.

### DETAILED DESCRIPTION OF THE INVENTION

FIG. 1 illustrates schematically, in cross section, a preferred embodiment of the pipe joint according to the invention in the assembled state. By means of a sealing element 4 and a clamp 3, a first pipe part 1 is connected to a second pipe part 2. The first pipe part 1 has a circumferential constriction 11 which merges into a funnel-like widened portion 12. Although it is not absolutely necessary, it is advantageous, in order to produce like parts, for the second pipe part 2 to have its end region configured in the same way as the first pipe part 1, as is illustrated. The pipe joint is formed overall so as to achieve a gas-tight connection or joint between the pipe parts 1, 2. This is based on a preferred gas-flow direction corresponding to the arrow 14.

According to the invention, the sealing element 4 comprises a sleeve 5 with an encircling sealing ring 6 arranged approximately in the center. The sleeve 5 has a radially widened portion 8 at its first end 7. The illustration of FIG. 1 is based here on a cross section running through two diametrically opposite widened portions. The sleeve 5 also has a conically tapering region 10 at its second end 9. The sealing ring 6 is preferably formed so as to produce, in cross section, a radially outwardly tapering truncated cone with a rectilinear starting region, by way of which the sealing ring 6 butts against the sleeve 5 all the way around the outside of the latter.

In order to assemble the pipe joint, the sealing element 4 is pushed into the first pipe part 1. In this case, when the widened portion 8 of the sleeve 5 comes into contact with the circumferential constriction 11 of the pipe part 1, the widened circumferential region 8 is forced inward and, as the sleeve 5 is pushed in further, springs back again approximately into the starting position and engages behind the circumferential constriction 11. At the same time, the truncated-cone flank of the sealing ring 6 comes into abutment against the widened end 12 of the pipe part 1. This achieves axial fixing of the sealing element 4, with the result that it is no longer possible for the latter to slide out of the pipe part 1 as assembly continues. This facilitates assembly in particular in the case of the pipe part 1 being directed geodetically downward.

For assembly purposes, it is advantageous for between three and ten widened portions 8, preferably designed to project in the manner of teeth, to be distributed uniformly along the circumferential line of the sleeve end 7. More widened portions require an increased level of force to be applied when the sealing element 4 is forced into the pipe part 1, whereas fewer widened portions may result in tilting. It is advantageous, furthermore, for the sleeve 5 to be provided, between the end regions 7, 9, with an external diameter which is only slightly smaller than the internal diameter of the pipe part 1 in the region of the circumferential constriction 11, so that the sleeve butts against this region. The circumferential constriction 11 is preferably dimensioned such that the internal diameter of the pipe parts 1, 2 is reduced by approximately 1% to 4% at this location.

To continue assembly, the second pipe part 2 is plugged onto the conically tapered end 9 of the sleeve until the end 13, which is widened in a funnel-like manner, butts against the flank of the sealing ring 6. The conically tapered portion 10 of the sleeve proves to be advantageous here in two respects. On the one hand, the second pipe part 2 can be plugged on obliquely to a certain extent, which is beneficial, for example, in the case of exhaust pipes which are difficult to access. On the other hand, a circumferential gap 15 is produced between the sleeve 5, at its end 9, and the second pipe part 2, with the result that the pipe joint can easily be of angled configuration and the pipes can thus deviate to a certain extent from a rectilinear course. The conically tapered end region of the sleeve 5 preferably extends axially in the flow direction to behind the circumferential constriction of the second pipe part 2.

A fixed and preferably gas-tight connection or joint between the pipe parts 1, 2 is achieved by means of the clamp 3 with a more or less U-shaped cross section. For this purpose, the clamp 3 is positioned around the widened ends 12, 13 of the pipe parts 1, 2 so that the flanks of the clamp engage over these ends. It is advantageous here if the flank angles of the clamp 3 and of the sealing ring 6 correspond approximately to the flank angle of the widened ends 12, 13 of the pipe parts 1, 2. Angling of the ends 12, 13 by approximately 70° in relation to the pipe axis is preferred. The clamp 3 may be configured here in a conventional manner with at least one open location. It is advantageous, for example, to have a clamp with two semicircular halves which are connected in a movable manner at one end and can be closed and tightened by a screw connection at the other end. For tightening purposes, it is possible here for the clamp to slide in the direction of the circumferential constrictions of the pipe parts 1, 2, as a result of which the sealing ring 6 is pressed with sealing action against the widened ends 12, 13 of the pipe parts 1, 2. Sliding axial deformation of the sealing ring 6 is made possible here by it having a region of rectangular cross section in the radially inward direction.

For the handling and assembly of the pipe joint according to the invention, it is advantageous if the sealing ring 6 is arranged in a fixed position on the sleeve 5. This can be achieved, for example, by an encircling annular bead of the sleeve 5 interacting with a corresponding circumferential groove on the bearing surface of the sealing ring 6. It is preferred for the sealing ring 6 to be connected in a form-fitting manner and, if appropriate, force-fitting manner to the sleeve, captive arrangement being ensured as a result.

For a gas-tight pipe joint in an exhaust-gas system of an internal combustion engine, it is advantageous if the sealing ring 6 has a corresponding level of temperature resistance and deformability. It is thus provided for the sealing ring 6 to be made of a temperature-resistant sealing material. Although it is also possible to use other sealing materials, for example Kevlar, aluminum or copper, it is advantageous if the sealing ring is made from an at least partially, but preferably from a predominantly, graphite-filled knitted wire fabric. The use of graphite or of a predominantly graphite-containing sealing material results in good sliding properties, jamming of the sealing ring thus being avoided. Graphite, moreover, exhibits good thermal and chemical resistance. The knitted wire fabric ensures a sufficient level of deformability and flexibility and also ensures that the graphite is held together mechanically. Furthermore, the knitted wire fabric prevents the sealing material from moving away in a radial direction and thus prevents the pipe joint from loosening. In addition, using the knitted wire fabric allows the fixed, preferably non-releasable connection of the sealing ring 6 to the metallic sleeve 5, a single-piece sealing element 4 being formed as a result.

In respect of the radial thickness of the sealing ring 6, it is advantageous if, together with the sleeve 5, the overall external diameter achieved for the sealing element 4 does not exceed the largest diameter of the widened end 12, 13 of the pipe parts 1, 2, so that a radial projection is avoided. A slightly smaller largest diameter of the sealing element 4, as is illustrated in FIG. 1, is particularly preferred. In respect of the width of the sealing ring 6, it is advantageous if this width is dimensioned so as to give an axial spacing between the pipe parts of approximately 5% to 50% of the pipe-part diameter.

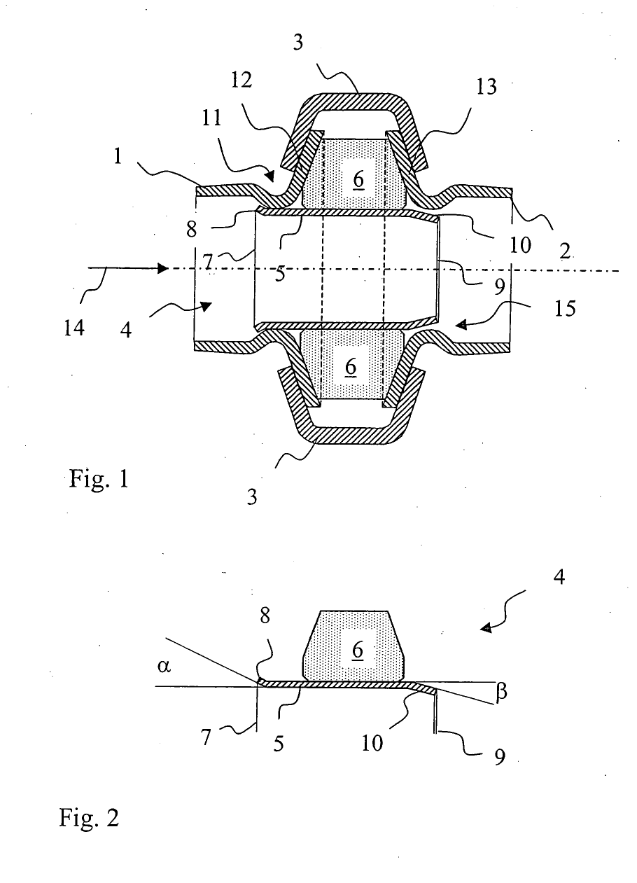

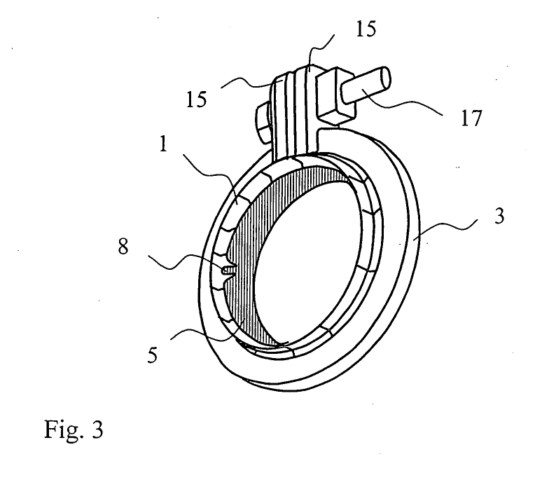

FIG. 2 is used hereinbelow to discuss a preferred configuration of the sealing element 4 and, in particular, of the sleeve 5. The same components are provided with the same designations here as in FIG. 1. As is illustrated in FIG. 2, the radially widened portion 8 of the sleeve 5 is configured at an angle of α in relation to the axial course taken by the sleeve 5. A range of 15° to 35° is preferred for this angle α. The radially widened portion 8 is particularly preferably configured at an angle of α of approximately 25° and extends in the axial direction over a length of approximately 0.5% to 10%, preferably approximately 5%, in relation to the length of the sleeve 5. The conically tapered portion 10 of the sleeve diameter at the second end 9 of the sleeve 5 is preferably configured at a cone angle β of approximately 5° to 25°. A cone angle β of approximately 15° is particularly preferred. In respect of a connection or joint between exhaust pipes of a motor vehicle and the dimensions which are customary in this case, the conically tapered portion 10 preferably has an extent of approximately 1% to 30%, particularly preferably approximately 15%, in relation to the length of the sleeve 5 in the axial direction.

FIG. 3 shows a schematic view in perspective of the assembled pipe joint according to FIG. 1, the same components being provided with the same designations. FIG. 3 merely illustrates a short section of the pipe part 1, while the second pipe part connected thereto is not illustrated. According to FIG. 3, the widened portion 8 of the sleeve 5, this widened portion projecting in the manner of teeth, makes up only a small part of the circumference of the sleeve 5 and is bounded by an axial notch in each case. In the case of exhaust pipes with a diameter of approximately 80 mm, a width of approximately 1 mm to 3 mm is advantageous for the widened portion 8, which projects in the manner of teeth. Corresponding relative dimensions are advantageous for other diameters. Although it is possible to provide a plurality of tooth-like widened portions, FIG. 3, for the sake of clarity, illustrates just one tooth-like widened portion.

A screw connection 17 is provided for closing the clamp 3, for which purpose the clamp 3 has, in the region of the closure, radially angled ends 15 which can be tightened by the screw connection 17, with the result that the clamp 3 compresses the pipe parts axially. It is nevertheless also possible to use other conventional types of closure, for example a tensioning closure, for the clamp 3.

1-8. (canceled)

9. A pipe joint for an exhaust-gas system of an internal combustion engine, comprising:
a first pipe part,
a second pipe part,
a fastener, and
a sealing element which has a sleeve and a sealing ring,
wherein the sleeve has a plurality of spaced-apart widened circumferential regions at a first end and can be pushed into the first pipe part such that the widened circumferential regions engage behind a circumferential constriction of the first pipe part in a resilient manner.

10. The pipe joint as claimed in claim 9, wherein the widened circumferential regions are designed to project in the manner of teeth.

11. The pipe joint as claimed in claim 9, wherein the sleeve has a conically tapered portion at a second end.

12. The pipe joint as claimed in claim 9, wherein the sealing ring encloses the sleeve in an annular manner and is connected to the sleeve in a form-fitting manner.

13. The pipe joint as claimed in claim 9, wherein the sealing ring is designed in a cross-sectionally frustoconical manner with a rectilinear starting region and with a radially outer region having a smaller width than a radially inner region.

14. The pipe joint as claimed in claim 9, wherein the sealing ring is made of a graphite-filled knitted wire fabric.

15. The pipe joint as claimed in claim 9, wherein each of the first and second pipe parts has a funnel-like widened portion at its connecting end.

16. The pipe joint as claimed in claim 9, wherein the fastener is designed as a clamp which is open at at least one location and which has cross-sectionally oblique flanks and a radially projecting closure part.

17. The pipe joint as claimed in claim 10, wherein the sleeve has a conically tapered portion at a second end.

18. The pipe joint as claimed in claim 10, wherein the sealing ring encloses the sleeve in an annular manner and is connected to the sleeve in a form-fitting manner.

19. The pipe joint as claimed in claim 11, wherein the sealing ring encloses the sleeve in an annular manner and is connected to the sleeve in a form-fitting manner.

20. The pipe joint as claimed in claim 10, wherein the sealing ring is designed in a cross-sectionally frustoconical manner with a rectilinear starting region and with a radially outer region having a smaller width than a radially inner region.

21. The pipe joint as claimed in claim 11, wherein the sealing ring is designed in a cross-sectionally frustoconical manner with a rectilinear starting region and with a radially outer region having a smaller width than a radially inner region.

22. The pipe joint as claimed in claim 12, wherein the sealing ring is designed in a cross-sectionally frustoconical manner with a rectilinear starting region and with a radially outer region having a smaller width than a radially inner region.

23. The pipe joint as claimed in claim 10, wherein the sealing ring is made of a graphite-filled knitted wire fabric.

24. The pipe joint as claimed in claim 11, wherein the sealing ring is made of a graphite-filled knitted wire fabric.

25. The pipe joint as claimed in claim 12, wherein the sealing ring is made of a graphite-filled knitted wire fabric.

26. The pipe joint as claimed in claim 13, wherein the sealing ring is made of a graphite-filled knitted wire fabric.

27. The pipe joint as claimed in claim 10, wherein each of the first and second pipe parts has a funnel-like widened portion at its connecting end.

28. The pipe joint as claimed in claim 11, wherein each of the first and second pipe parts has a funnel-like widened portion at its connecting end.
